(19) United States
(12) Patent Application Publication
(10) Pub. No.: US 2012/0033929 A1
(43) Pub. Date: Feb. 9, 2012

(54) GUIDE STRUCTURE OF OPTICAL FIBER AND WIRING METHOD OF OPTICAL FIBER

(75) Inventor: Nobuyuki HORIE, Oyama-shi (JP)

(73) Assignee: FUJITSU TELECOM NETWORKS LIMITED, Kawasaki-shi (JP)

(21) Appl. No.: 13/172,314

(22) Filed: Jun. 29, 2011

(30) Foreign Application Priority Data
Aug. 5, 2010 (JP) 2010-176270

(51) Int. Cl. G02B 6/00; B23P 11/00

(52) U.S. Cl. 385/135; 29/428

(57) ABSTRACT

A guide structure of an optical fiber includes a case in which a plurality of guide pin mounting holes are provided in accordance with the wiring route of the optical fiber, a plurality of guide pins formed of a conductive material, detachably attached to each of the guide pin mounting holes, and pulled out of each of the guide pin mounting holes after wiring the optical fiber, and providing a guide for wiring the optical fiber at the case by inserting each of the guide pins into each of the guide pin mounting holes.

### CROSS REFERENCE TO RELATED APPLICATION

This application is based upon and claims the benefit of priority from Japanese Patent Application No. 2010-176270, filed on Aug. 5, 2010, the entire contents of which are incorporated herein by reference.

### BACKGROUND

1. Field

The present application relates to a guide structure of an optical fiber and a wiring method of the optical fiber keeping a wiring route of the optical fiber uniform.

2. Description of the Related Art

A lot of optical parts are mounted inside an optical communication apparatus and an optical module, and various functions are enabled by coupling these optical parts with an optical fiber and wiring an optical circuit inside an apparatus or a product. Accordingly, a lot of optical fibers are wired inside the optical communication apparatus and the optical module.

Incidentally, the optical fiber is made of a quartz glass, and therefore, it is fractured when excessive bending stress is applied. Besides, light passing inside the optical fiber goes straight, and therefore, bending loss occurs when more than a predetermined bending is applied to incur deterioration of light amount and there is a case when product characteristics are not satisfied.

Accordingly, when wiring of the optical fiber is performed inside the optical communication apparatus and the optical module, it is necessary for operators to perform the wiring work while paying attention so that the optical fiber does not become a predetermined radius or less. However, an actual circumstance is that it is difficult to keep the wiring route of the optical fiber uniform resulting from variation in operations.

There is a method in which a fiber guide is provided at the wiring route as a method enabling a structure so that the optical fiber does not become the predetermined radial or less. Besides, a technology as for a wiring jig of electric wires is disclosed in Japanese Utility Model Application Publication No. H07-3228, in which electric wire holders are inserted and fixed to mounting holes at corresponding positions of a wiring path of a base plate in which a number of mounting holes are formed with a predetermined pitch, and the electric wires are wired via the electric wire holders.

However, there have been defects in which the fiber guides have to be designed and manufactured by each product because the wiring routes of the optical fiber are different by each component and product type to be mounted, in addition, a cost for fiber guide members is further required as a parts cost of the product because the fiber guide is mounted at the product, if the fiber guide is provided at the wiring route as stated above.

Similarly, there also is a problem in a conventional example disclosed in Japanese Utility Model Application Publication No, H07-3228 in which a cost for the electric wire holder is necessary as the parts cost of the product because the electric wire holders are inserted and fixed to the base plate.

### SUMMARY

The present application is made to address to these actual circumstances, and a proposition thereof is to provide a guide structure of an optical fiber and a wiring method of the optical fiber capable of keeping a wiring route of the optical fiber uniform and enabling suppression of a parts cost.

To attain the above-stated proposition, a guide structure of an optical fiber according to one embodiment of the present invention includes a case in which a plurality of guide pin mounting holes are provided in accordance with a wiring route of the optical fiber, a plurality of guide pins formed of a conductive material, detachably attached to each of the guide pin mounting holes, and pulled out of each of the guide pin mounting holes after wiring the optical fiber, and providing a guide for wiring the optical fiber at the case by inserting each of the guide pins into each of the guide pin mounting holes.

Besides, a guide structure of an optical fiber according to another embodiment of the present invention includes a printed circuit board in which a plurality of guide pin mounting holes are provided in accordance with a wiring route of the optical fiber, a plurality of guide pins formed of a conductive material, detachably attached to each of the guide pin mounting holes, and pulled out of each of the guide pin mounting holes after wiring the optical fiber, and providing a guide for wiring the optical fiber at the printed circuit board by inserting each of the guide pins into each of the guide pin mounting holes.

Further, the guide structure of the optical fiber according to still another embodiment of the present invention provides a lift preventing unit of the optical fiber at the guide pin in the guide structure.

In the guide structure of the optical fiber of the present invention according to yet another embodiment, the lift preventing unit is a concave portion formed at an outer periphery of the guide pin, and in further another embodiment of the present invention, the lift preventing unit is a projection projectingly provided at an upper outer periphery of the guide pin.

On the other hand, a wiring method of an optical fiber according to one embodiment of the present invention, includes providing a plurality of guide pin mounting holes at a case in accordance with a wiring route of the optical fiber when a number of optical parts are mounted on the case and these optical parts are coupled with the optical fiber, mounting the optical parts at the case after providing a guide for wiring the optical fiber at the case by inserting each of guide pins into each of the guide pin mounting holes, wiring the optical fiber along the guide pins and coupling each of the optical parts with the optical fiber, and pulling each of the guide pins out of each of the guide pin mounting holes after wiring the optical fiber.

Besides, a wiring method of an optical fiber according to another embodiment of the present invention, includes providing a plurality of guide pin mounting holes at a printed circuit board disposed on a case in accordance with a wiring route of the optical fiber when a number of optical parts are mounted on the case or the printed circuit board and these optical parts are coupled with the optical fiber, mounting the optical parts at the case or the printed circuit board after providing a guide for wiring the optical fiber at the printed circuit board by inserting each of guide pins into each of the guide pin mounting holes, wiring the optical fiber along the guide pins and coupling each of the optical parts with the optical fiber, and pulling each of the guide pins out of each of the guide pin mounting holes after wiring the optical fiber.

The present invention according to still another embodiment provides a lift preventing unit of the optical fiber at the guide pin to prevent a lifting of the optical fiber at the time of wiring in the wiring method.

According to the guide structure of the optical fiber of the above-stated embodiments, the uniformity and the stabilization of the wiring route of the optical fiber are enabled by the guide wired by the guide pins at the time of wiring the optical fiber, and therefore, the quality is stabilized.

Besides, the guide pins pulled out of the guide pin mounting holes after the wiring are reusable, and therefore, there is an advantage that parts cost is reduced compared to a conventional guide structure in which fiber guides are mounted by each product.

The lift preventing unit provided at the guide pin prevents the lifting of the optical fiber at the time of wiring the optical fiber, and therefore, there is an advantage of high workability. Also, by making the lifting preventing unit be the concave portion, there is an advantage in which an attachment/detachment operation of the guide pin is easy because it is possible to insert the guide pin into the guide pin mounting hole regardless of top and bottom of the guide pin, and further, the projection functions as the grip portion of the guide pin by providing the projection at the upper portion of the guide pin.

On the other hand, according to the wiring method of the optical fiber of the above-stated embodiments, it is possible to form the guide at the case and the printed circuit board by the simple work of attaching/detaching the guide pins to/from the guide pin mounting holes formed at the case and the printed circuit board. As a result, there is an advantage in which the uniformity and the stabilization of the wiring route of the optical fiber are enabled by the guide at the time of wiring the optical fiber.

In addition, it is possible to enable the uniformity and the stabilization of the wiring route for any number of times by using the reusable guide pins and further, there is an advantage of high workability because the lift preventing unit provided at the guide pin prevents the lifting of the optical fiber at the time of wiring the optical fiber.

### BRIEF DESCRIPTION OF THE DRAWINGS

FIG. 1 is an entire perspective view of a case and guide pins used for a guide structure of an optical fiber.

FIG. 2 is an enlarged side view of the guide pin inserted into a guide pin mounting hole of the case.

FIG. 3 is an entire perspective view of the case in which a guide is formed by the guide pins.

FIG. 4 is an entire perspective view of the case and optical parts mounted thereon.

FIG. 5 is an entire perspective view of the case in which wiring of the optical fiber is performed.

FIG. 6 is an explanatory view of a wiring method of the optical fiber.

FIG. 7 is an entire perspective view of the case, a printed circuit board, and a cover attached thereto.

FIG. 8 is an entire perspective view of a completed communication apparatus.

FIG. 9 is an enlarged side view of a guide pin inserted into a guide pin mounting hole.

FIG. 10 is an entire perspective view of a case and a printed circuit board used for a guide structure of an optical fiber.

FIG. 11 is an entire perspective view of the printed circuit board and the guide pins disposed on the case.

FIG. 12 is an entire perspective view of the printed circuit board and optical parts mounted thereon.

FIG. 13 is an entire perspective view of the printed circuit board in which wiring of the optical fiber is performed.

FIG. 14 is an explanatory view of a wiring method of the optical fiber.

FIG. 15 is an entire perspective view of the printed circuit board disposed on the case and a cover attached thereto.

FIG. 16 is an entire perspective view of a completed communication apparatus.

### DESCRIPTION OF THE PREFERRED EMBODIMENTS

Hereinafter, embodiments of the present invention are described in detail based on the drawings.

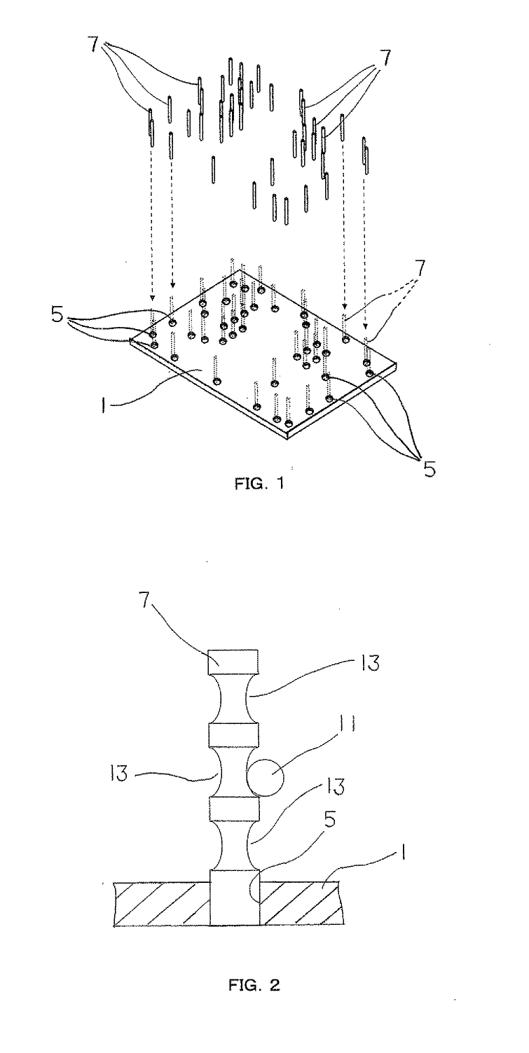

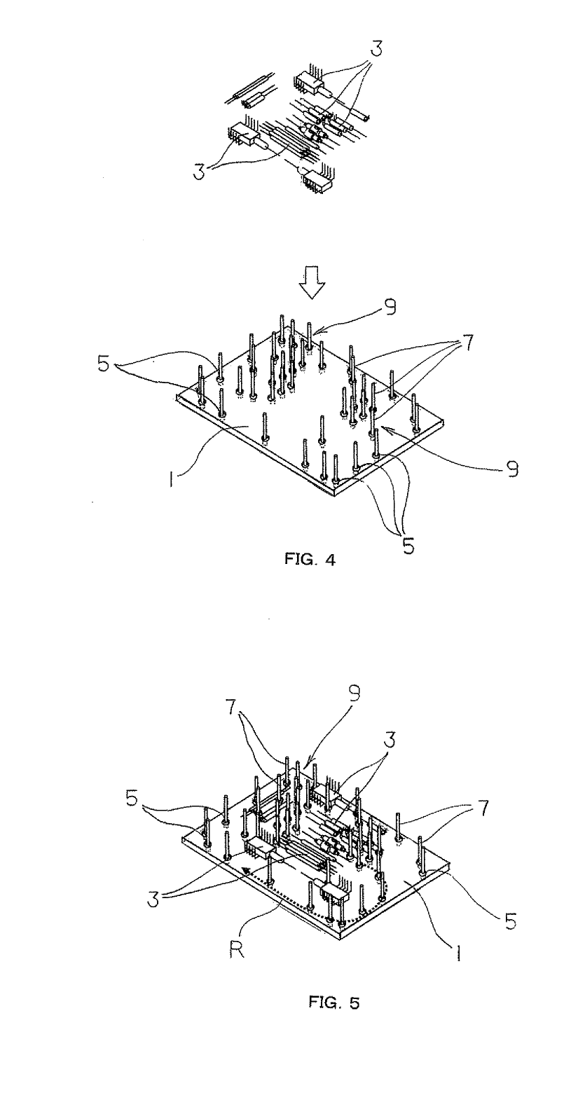

FIG. 1 to FIG. 6 represent a guide structure of an optical fiber according to one embodiment of the present invention. In FIG. 1, a reference numeral 1 is a case (lower case) in a rectangular state when seen from above to which optical parts 3 such as a laser diode illustrated in FIG. 4 are mounted, and a number of guide pin mounting holes 5 in a circular state when seen from above are provided at the case 1 in accordance with a wiring route R of an optical fiber illustrated in FIG. 5, to mount the optical parts 3.

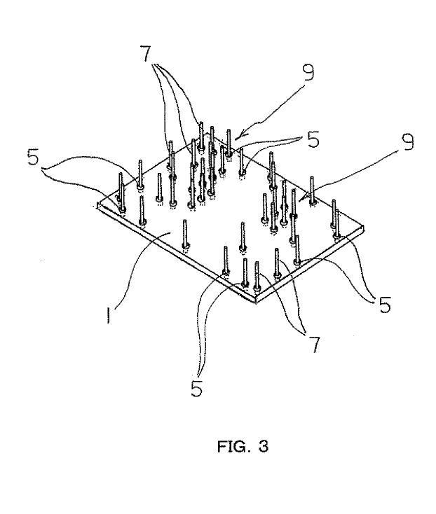

Besides, reference numerals 7 are guide pins each in a circular shape in cross section which are attachable/detachable to/from each of the guide pin mounting holes 5 in FIG. 1. A guide 9 in which wiring of the optical fiber is performed along the wiring route R is formed on the case 1 by each of the guide pins 7 when the guide pins 7 are inserted into each of the guide pin mounting holes 5 as illustrated in FIG. 1 and FIG. 3.

As illustrated in FIG. 2, a plurality of annular concave portions (lift preventing unit) 13 each in an arc-shape in cross section are provided at upward and downward in a circumferential direction, at an outer periphery of the guide pin 7, to prevent lifting of an optical fiber 11 at the time of wiring.

A guide structure of the optical fiber 11 using the guide pins 7 is made up as stated above, and a wiring method of the optical fiber 11 according to one embodiment of the present invention by using the guide pins 7 is embodied as stated below.

At first, the guide pins 7 are inserted into the guide pin mounting holes 5 from upward of the case 1 as illustrated in FIG. 1 to form the guide 9 made up of the plurality of guide pins 7 on the case 1 as illustrated in FIG. 3 before the optical parts 3 are mounted on the case 1 where the guide pin mounting holes 5 are provided.

After the optical parts 3 are mounted at predetermined positions at a surface of the case 1 as illustrated in FIG. 4, the wiring of the optical fiber 11 is performed at the wiring route R along the guide 9 as illustrated in FIG. 5, and an optical circuit is formed by coupling the optical parts 3 with the optical fiber 11.

The annular concave portions 13 provided at the outer periphery of the guide pin 7 as illustrated in FIG. 2 prevent the lifting of the optical fiber 11 at the time of wiring the optical fiber 11, and the guide 9 made up of the guide pins 7 holds the optical fiber 11 at important points of pass-through points of the wiring route R, and thereby, a constant wiring route R of the optical fiber 11 is kept.

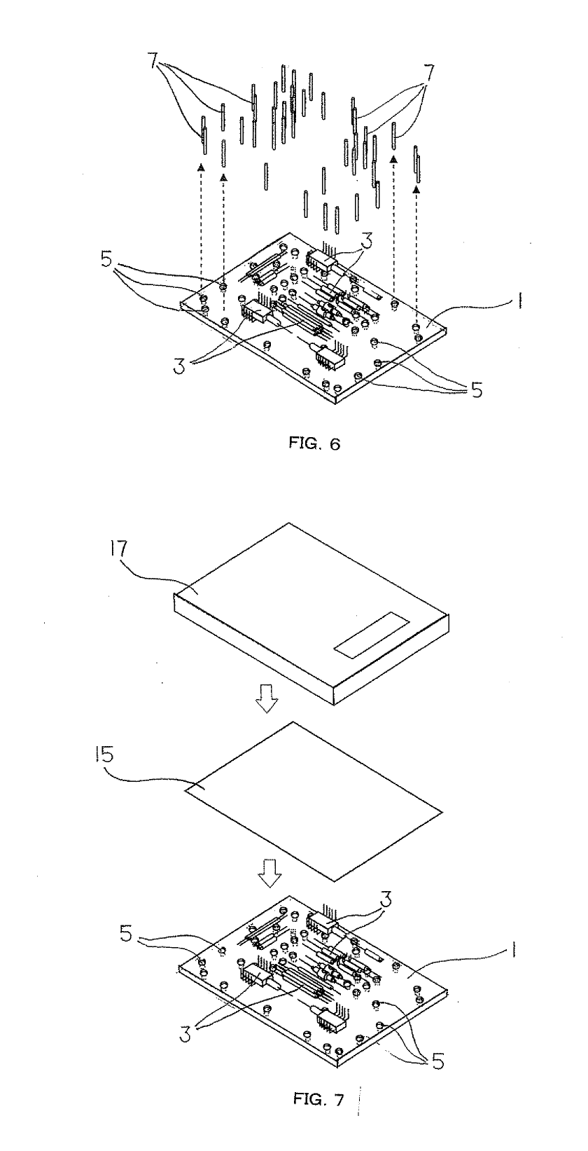

After that, the guide pins 7 are pulled out toward upward from each of the guide pin mounting holes 5 as illustrated in FIG. 6, and the optical fiber 11 wired at the case 1 does not become the predetermined radius or less because it expands toward outside by its own tension when the guide 9 is disappeared by pulling out the guide pins 7.

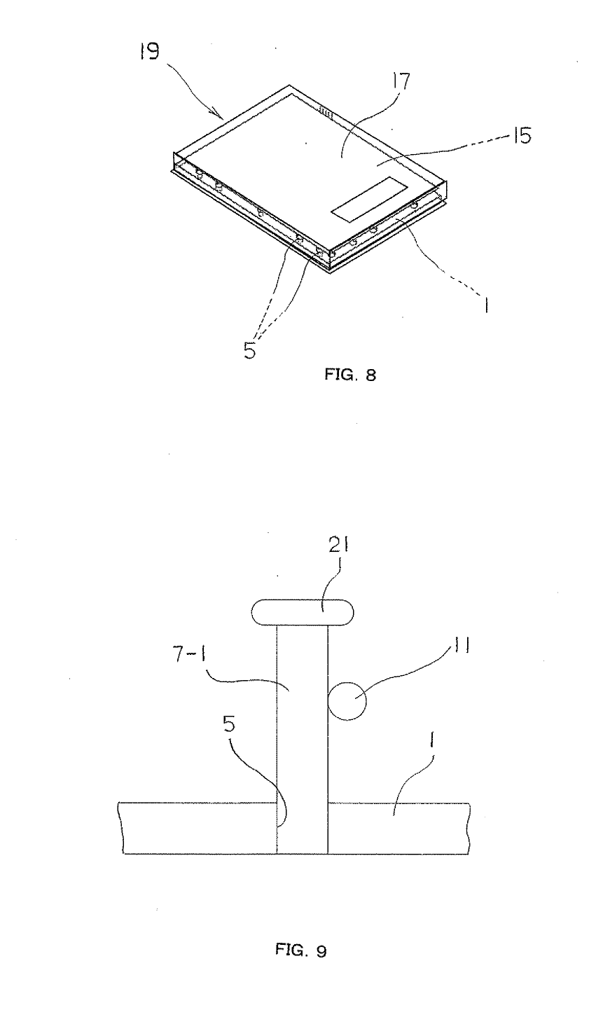

A printed circuit board 15 is disposed on the case 1 as illustrated in FIG. 7, the optical parts 3 are coupled to a pattern of the printed circuit board 15, a communication apparatus 19 illustrated in FIG. 8 is manufactured by finally covering the above with a cover (an upper case) 17, and the plurality of guide pins 7 pulled out of the case 1 are reusable.

According to the guide structure of the optical fiber 11 of the present embodiment, it is possible to uniformize and stabilize the wiring route R of the optical fiber 11 by the guide 9 formed by the guide pins 7 at the time of wiring the optical fiber 11, and therefore, a quality thereof becomes stable.

Besides, the annular concave portions 13 provided at the outer periphery of the guide pin 7 prevent the lifting of the optical fiber 11 at the time of wiring the optical fiber 11, and therefore, it excels in workability, and it is possible to insert the guide pin 7 into the guide pin mounting hole 5 regardless of top and bottom of the guide pin 7.

In addition, the guide pins 7 are reusable, and therefore, there is an advantage that a reduction in parts cost is enabled compared to a conventional guide structure in which fiber guides are mounted by each product.

According to the wiring method of the optical fiber 11 of one embodiment of the present invention, it is possible to form the guide 9 at the case 1 by the simple work of only inserting the guide pins 7 into the guide pin mounting holes 5 provided at the case 1, and the optical fiber 11 does not become the predetermined radius or less by expanding toward outside by its own tension even if the guide pins 7 are pulled out after wiring the optical fiber 11, and therefore, there is an advantage in which the uniformity and the stabilization of the wiring route R of the optical fiber 11 are enabled.

In addition, it is possible to enable the uniformity and the stabilization of the wiring route R for any number of times by using the reusable guide pins 7.

Note that the lifting of the optical fiber 11 at the time of wiring is prevented by providing the annular concave portions 13 in plural at the outer periphery of the guide pin 7 at upward and downward as illustrated in FIG. 2 in the above-stated both embodiments, but the lifting of the optical fiber 11 may be prevented by providing a wide disk-shaped projection (lift preventing unit) 21 preventing the lifting of the optical fiber 11 at the time of wiring at an upper portion of a guide pin 7-1 in a circular shape in cross-section attachable/detachable to/from the guide pin mounting hole 5, as another embodiment of the present invention illustrated in FIG. 9.

It is possible to attain the proposition by this embodiment as same as the above-stated embodiments, and the projection 21 functions as a grip portion of the guide pin 7-1, and therefore, there is an advantage in which an attachment/detachment operation of the guide pin 7-1 is easy.

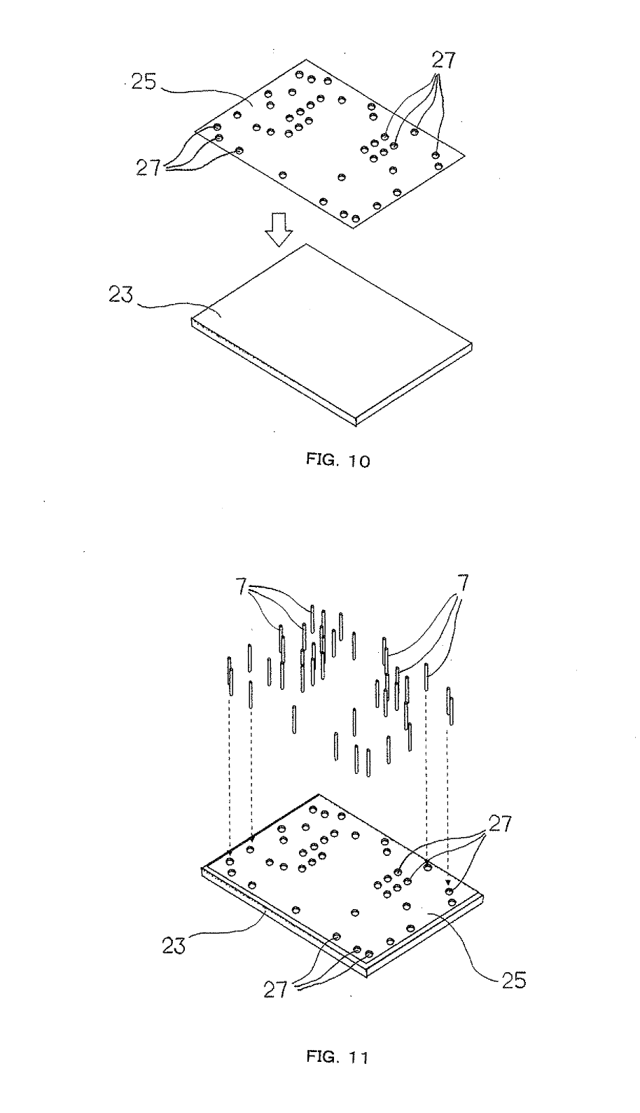

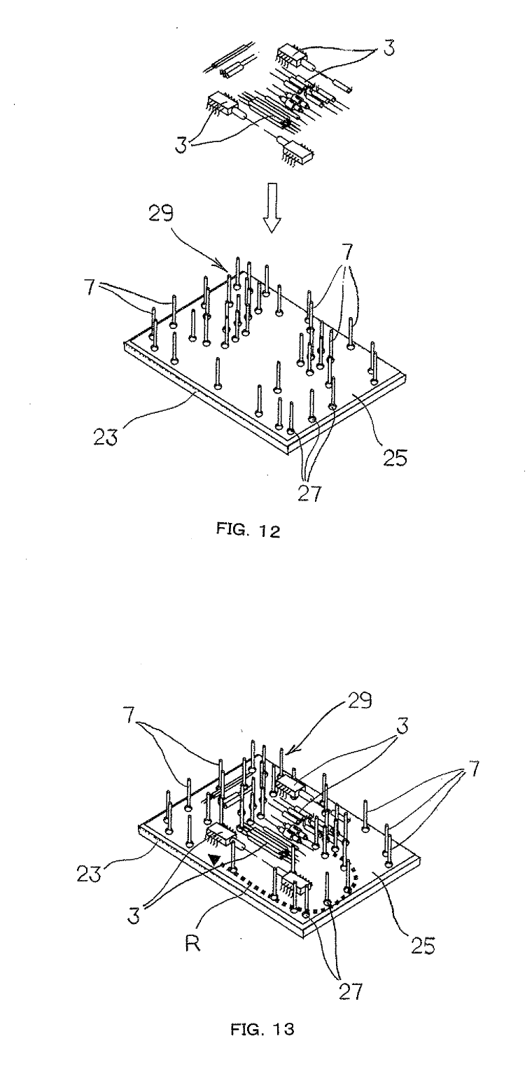

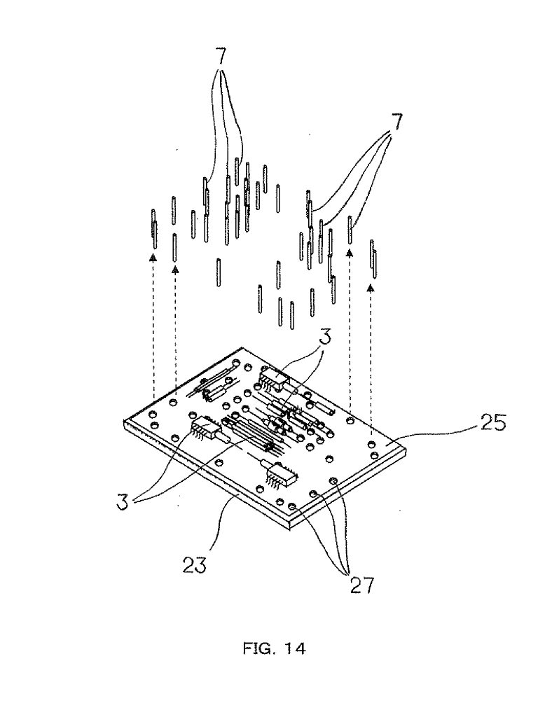

A guide structure of an optical fiber according to still another embodiment of the present invention is illustrated in FIG. 10 to FIG. 15. In FIG. 10, a reference numeral 23 is a case (lower case) in a rectangular state when seen from above, a reference numeral 25 is a printed circuit board disposed on the case 23, and the optical parts 3 such as a laser diode are mounted on the printed circuit board 25 in the present embodiment as illustrated in FIG. 12 and FIG. 13.

When the optical parts 3 are mounted on the printed circuit board 25, a number of guide pin mounting holes 27 in circular states when seen from above are provided at the printed circuit board 25 as same as the case 1 in accordance with the wiring route R of the optical fiber 11 illustrated in FIG. 13 as illustrated in FIG. 10. A guide 29 to perform wiring of the optical fiber 11 along the wiring route R is formed on the printed circuit board 25 by each of the guide pins 7 when the guide pins 7 are inserted into each of the guide pin mounting holes 27 as illustrated in FIG. 11 and FIG. 12.

A guide structure of the optical fiber 11 using the guide pins 7 is made up as stated above, and a wiring method of the optical fiber 11 according to another embodiment of the present invention is embodied as stated below by using the guide pins 7.

At first, the guide pins 7 are inserted into the guide pin mounting holes 27 from upward of the printed circuit board 25 as illustrated in FIG. 11 to form the guide 29 made up of the plurality of guide pins 7 on the printed circuit board 25 as illustrated in FIG. 12, before the optical parts 3 are mounted on the printed circuit board 25 disposed on the case 1.

After the optical parts 3 are mounted at predetermined positions at a surface of the printed circuit board 25 as illustrated in FIG. 12 and coupled to a pattern, the wiring of the optical fiber 11 is performed at the wiring route R along the guide 29 as illustrated in FIG. 13, and an optical circuit is formed by coupling the optical parts 3 with the optical fiber 11.

The annular concave portions 13 provided at the outer periphery of the guide pin 7 prevent the lifting of the optical fiber 11 at the time of wiring the optical fiber 11 as same as FIG. 2, and the guide 29 made up of the guide pins 7 holds the optical fiber 11 at important points of pass-through points of the wiring route R, and thereby, the constant wiring route R of the optical fiber 11 is kept.

After that, the guide pins 7 are pulled out toward upward from each of the guide pin mounting holes 27 as illustrated in FIG. 14, and the optical fiber 11 wired at the printed circuit board 25 does not become the predetermined radius or less by expanding toward outside by nits own tension as a result that the guide pins 7 are pulled out and the guide 29 disappears.

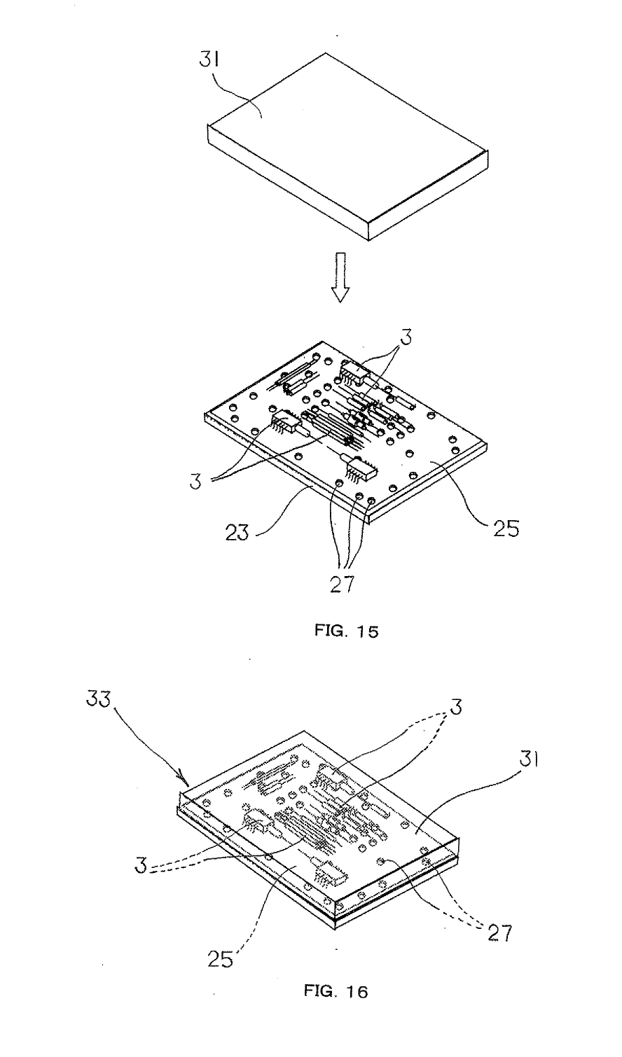

A communication apparatus 33 illustrated in FIG. 16 is manufactured by covering the case (lower case) 23 and the printed circuit board 25 with a cover (upper case) 31 as illustrated in FIG. 15, and the plurality of guide pins 7 pulled out of the printed circuit board 25 are reusable.

According to the guide structure of the optical fiber 11 of the present embodiment, it is also possible to uniformize and stabilize the wiring route R of the optical fiber 11 by the guide 29 formed by the guide pins 7 at the time of wiring the optical fiber 11, and therefore, the quality thereof becomes stable.

Besides, the annular concave portions 13 provided at the outer periphery of the guide pin 7 prevent the lifting of the optical fiber 11 at the time of wiring the optical fiber 11, and therefore, it excels in workability, and it is possible to insert the guide pin 7 into the guide pin mounting hole 27 regardless of top and bottom of the guide pin 7.

In addition, the guide pins 7 are reusable, and therefore, there is an advantage that a reduction in parts cost is enabled compared to a conventional guide structure in which fiber guides are mounted by each product.

According to the above-stated wiring method of the optical fiber 11 of one embodiment of the present invention, it is possible to form the guide 29 on the printed circuit board 25 by the simple work of inserting the guide pins 7 into the guide pin mounting holes 27 provided at the printed circuit board 25, and the optical fiber 11 does not become the predetermined radius or less by expanding toward outside by its own tension even if the guide pins 7 are pulled out after wiring the optical fiber 11, and therefore, there is an advantage in which the uniformity and the stabilization of the wiring route R of the optical fiber 11 are enabled.

In addition, it is possible to enable the uniformity and the stabilization of the wiring route R for any number of times by using the reusable guide pins 7.

It is also possible to use the guide pin 7-1 illustrated in FIG. 9 in these respective embodiments, and there is an advantage in which the attachment/detachment operation of the guide pin 7-1 is easy because the projection 21 functions as the grip portion of the guide pin 7-1.

Besides, the structure in which the optical parts 3 are mounted on the printed circuit board 25 is described in the embodiment after FIG. 10, but the present invention is also applicable for a specification in which the optical parts and the printed circuit board are mounted on the case, and thereafter, the wiring of the optical fiber is performed on the printed circuit board.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

1. A guide structure of an optical fiber, comprising:
a case in which a plurality of guide pin mounting holes are provided in accordance with a wiring route of the optical fiber;
a plurality of guide pins formed of a conductive material, detachably attached to each of the guide pin mounting holes, and pulled out of each of the guide pin mounting holes after wiring the optical fiber; and
providing a guide for wiring the optical fiber at the case by inserting each of the guide pins into each of the guide pin mounting holes.

2. A guide structure of an optical fiber, comprising:
a printed circuit board in which a plurality of guide pin mounting holes are provided in accordance with a wiring route of the optical fiber;
a plurality of guide pins formed of a conductive material, detachably attached to each of the guide pin mounting holes, and pulled out of each of the guide pin mounting holes after wiring the optical fiber; and
providing a guide for wiring the optical fiber at the printed circuit board by inserting each of the guide pins into each of the guide pin mounting holes.

3. The guide structure of the optical fiber according to claim 1, wherein
the guide pin has a lift preventing unit of the optical fiber.

4. The guide structure of the optical fiber according to claim 3, wherein
the lift preventing unit is a concave portion formed at an outer periphery of the guide pin.

5. The guide structure of the optical fiber according to claim 3, wherein
the lift preventing unit is a projection projectingly provided at an upper outer periphery of the guide pin.

6. A wiring method of an optical fiber, comprising:
providing a plurality of guide pin mounting holes at a case in accordance with a wiring route of the optical fiber when a number of optical parts are mounted on the case and the optical parts are coupled with the optical fiber;
mounting the optical parts at the case after providing a guide for wiring the optical fiber at the case by inserting each of guide pins into each of the guide pin mounting holes;
wiring the optical fiber along the guide pins and coupling each of the optical parts with the optical fiber; and
pulling each of the guide pins out of each of the guide pin mounting holes after wiring the optical fiber.

7. A wiring method of an optical fiber, comprising:
providing a plurality of guide pin mounting holes at a printed circuit board disposed on a case in accordance with a wiring route of the optical fiber when a number of optical parts are mounted on one of the case and the printed circuit board and the optical parts are coupled with the optical fiber;
mounting the optical parts at one of the case and the printed circuit board after providing a guide for wiring the optical fiber at the printed circuit board by inserting each of guide pins into each of the guide pin mounting holes;
wiring the optical fiber along the guide pins and coupling each of the optical parts with the optical fiber; and
pulling each of the guide pins out of each of the guide pin mounting holes after wiring the optical fiber.

8. The wiring method of the optical fiber according to claim 6, wherein
the guide pin has a lift preventing unit of the optical fiber to prevent a lifting of the optical fiber at a time of wiring.

9. The guide structure of the optical fiber according to claim 2, wherein
the guide pin has a lift preventing unit of the optical fiber.

10. The wiring method of the optical fiber according to claim 7, wherein
the guide pin has a lift preventing unit of the optical fiber to prevent a lifting of the optical fiber at a time of wiring.

11. The guide structure of the optical fiber according to claim 9, wherein
the lift preventing unit is a concave portion formed at an outer periphery of the guide pin.

12. The guide structure of the optical fiber according to claim 9, wherein
the lift preventing unit is a projection projectingly provided at an upper outer periphery of the guide pin.
